(19) United States
(12) Patent Application Publication
(10) Pub. No.: US 2011/0188708 A1
(43) Pub. Date: Aug. 4, 2011

(54) THREE-DIMENSIONAL EDGE EXTRACTION METHOD, APPARATUS AND COMPUTER-READABLE MEDIUM USING TIME OF FLIGHT CAMERA

(75) Inventors: Sung Hwan AHN, Anyang-si (KR); Kyung Shik ROH, Seongnam-si (KR); Suk June YOON, Seoul (KR); Seung Yong HYUNG, Yongin-si (KR)

(73) Assignee: Samsung Electronics Co., Ltd., Suwon-si (KR)

(21) Appl. No.: 12/961,655

(22) Filed: Dec. 7, 2010

(30) Foreign Application Priority Data
Dec. 8, 2009 (KR) 10-2009-0121305

(51) Int. Cl. G06K 9/00

(52) U.S. Cl. 382/106; 382/154

(57) ABSTRACT

A method of extracting a three-dimensional (3D) edge is based on a two-dimensional (2D) intensity image and a depth image acquired using a time of flight (TOF) camera. The 3D edge extraction method includes acquiring a 2D intensity image and a depth image using a TOF camera, acquiring a 2D edge image from the 2D intensity image, and extracting a 3D edge using a matched image obtained by matching the 2D intensity image and the depth image.

### CROSS-REFERENCE TO RELATED APPLICATIONS

This application claims the benefit of Korean Patent Application No. 10-2009-0121305, filed on Dec. 8, 2009 in the Korean Intellectual Property Office, the disclosure of which is incorporated herein by reference.

### BACKGROUND

1. Field

Example embodiments relate to a method, apparatus and computer-readable medium that extract a three-dimensional (3D) edge based on a two-dimensional (2D) intensity image and a depth image acquired using a time of flight (TOF) camera.

2. Description of the Related Art

With development of intelligent unmanned technology, much research is being conducted into a self-location recognition technology and intelligent route design. For a moving platform (for example, a cleaning robot, a service robot or a humanoid robot) to move in an autonomous manner, the platform may recognize a location thereof with respect to an environment and avoid obstacles based on the recognized information. At this time, three-dimensional (3D) edge information with respect to the environment is used as a landmark or a feature point in recognizing the location of the moving platform, which is helpful to perform strong location recognition. The 3D edge information is continuously observed every frame to be a stable data point for location recognition with respect to the environment.

Also, the 3D edge information may be applied to 3D human modeling. The 3D human modeling is a core aspect of embodying a user interface (UI) that recognizes 3D human motion and moves accordingly. The 3D edge information may be used to acquire modeling information of the human motion. Also, the 3D edge information may reduce the amount of data to improve calculation performance.

The 3D edge information may be extracted mainly using a method of extracting an edge from a 2D image, a method of extracting an edge from 2D distance information, or a method of extracting a plane from 3D distance information.

A method of extracting an edge from a 2D image determines a part having a large brightness change or discontinuity of the image as an edge. A representative example thereof is canny edge detection. However, this method does not include 3D geometrical information, and a physically continuous part may be extracted as a discontinuous edge due to a brightness change.

A method of extracting an edge from 2D distance information projects distance information to a straight line model based on planar data obtained by a distance sensor, such as an ultrasonic sensor or a laser sensor, using Hough transform or random sample consensus (RANSAC) to extract an edge. This method expresses a 3D environment only on a 2D plane, with the result that the method is limited in extracting the edge in a complicated environment.

A method of extracting a plane from 3D distance information extracts a planar component using 3D distance data obtained by rotating a laser sensor and extracts an edge using the planar component. In this method, however, information to be processed is increased, resulting in an increased calculation time.

### SUMMARY

Therefore, it is an aspect of example embodiments to provide a method of extracting a three-dimensional (3D) edge based on a two-dimensional (2D) intensity image and a depth image acquired using a time of flight (TOF) camera.

The foregoing and/or other aspects are achieved by providing a three-dimensional (3D) edge extraction method including acquiring a two-dimensional (2D) intensity image and a depth image using a time of flight (TOF) camera, acquiring a 2D edge image from the 2D intensity image, and extracting a 3D edge using a matched image obtained by matching the 2D intensity image and the depth image.

The 3D edge extraction method may further include acquiring 3D distance information of an edge part of the matched image.

The 3D distance information may include depth information of the edge part of the matched image and 2D distance information of the edge part calculated using a pinhole camera. The 3D edge may be extracted using a random sample consensus (RANSAC) algorithm.

The foregoing and/or other aspects are achieved by providing a three-dimensional (3D) edge extraction method including acquiring a two-dimensional (2D) intensity image and a depth image using a time of flight (TOF) camera, acquiring a 2D edge image from the 2D intensity image, dilating an edge part of the 2D edge image to acquire a 2D edge candidate group image, and extracting a 3D edge using a matched image obtained by matching the 2D edge candidate group image and the depth image.

The 3D edge extraction method may further include acquiring 3D distance information of an edge candidate group part of the matched image.

The 3D distance information may include depth information of the edge candidate group part of the matched image and 2D distance information of the edge candidate group part calculated using a pinhole camera. The 3D edge may be extracted using a random sample consensus (RANSAC) algorithm.

The foregoing and/or other aspects are achieved by providing a three-dimensional (3D) edge extraction apparatus including an image acquisition unit having a time of flight (TOF) camera to acquire a two-dimensional (2D) intensity image and a depth image, a 2D edge image acquisition unit to extract a 2D edge image from the 2D intensity image, a matching unit to match the 2D edge image and the depth image, and a 3D edge extraction unit to extract a 3D edge from a matched image acquired by the matching unit.

The 3D edge extraction apparatus may further include a 3D distance information acquisition unit to acquire 3D distance information of an edge part of the matched image acquired by the matching unit. The 3D edge extraction unit may extract the 3D edge using a random sample consensus (RANSAC) algorithm.

The foregoing and/or other aspects are achieved by providing a three-dimensional (3D) edge extraction apparatus including an image acquisition unit having a time of flight (TOF) camera to acquire a two-dimensional (2D) intensity image and a depth image, a 2D edge image acquisition unit to extract a 2D edge image from the 2D intensity image, a 2D edge candidate group image acquisition unit to dilate an edge part of the 2D edge image to acquire a 2D edge candidate group image, a matching unit to match the 2D edge candidate group image and the depth image, and a 3D edge extraction unit to extract a 3D edge from a matched image acquired by the matching unit.

The 3D edge extraction apparatus may further include a 3D distance information acquisition unit to acquire 3D distance information of an edge part of the matched image acquired by the matching unit. The 3D edge extraction unit may extract the 3D edge using a RANSAC algorithm.

The foregoing and/or other aspects are achieved by providing at least one non-transitory computer readable medium including computer readable instructions that control at least one processor to implement methods of one or more embodiments.

Additional aspects, features, and/or advantages of embodiments will be set forth in part in the description which follows and, in part, will be apparent from the description, or may be learned by practice of the disclosure.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a block diagram schematically illustrating the construction of a three-dimensional (3D) edge extraction apparatus according to example embodiments;

FIG. 2, parts (a) and (b), are views illustrating examples of an intensity image and a depth image acquired using a time of flight (TOF) camera;

FIG. 3, parts (a) and (b), are views illustrating a two-dimensional (2D) edge image and a 2D edge candidate group image extracted from the intensity image acquired using the TOF camera;

FIG. 4, parts (a) and (b), are views illustrating matched images obtained by matching the 2D edge image and the 2D edge candidate group image with the depth image;

FIG. 5 is a view illustrating a 3D edge extraction result according to example embodiments; and

FIG. 6 is a flow chart illustrating a 3D edge extraction method according to example embodiments.

### DETAILED DESCRIPTION

Reference will now be made in detail to embodiments, examples of which are illustrated in the accompanying drawings, wherein like reference numerals refer to like elements throughout.

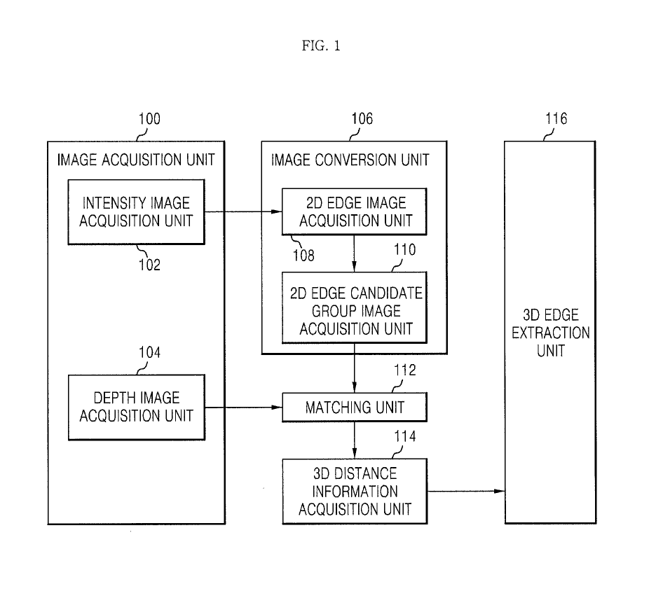

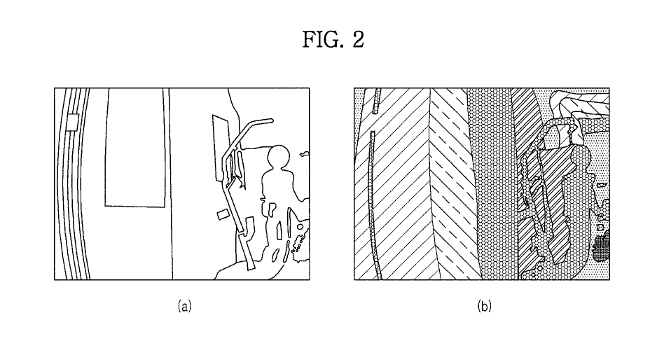

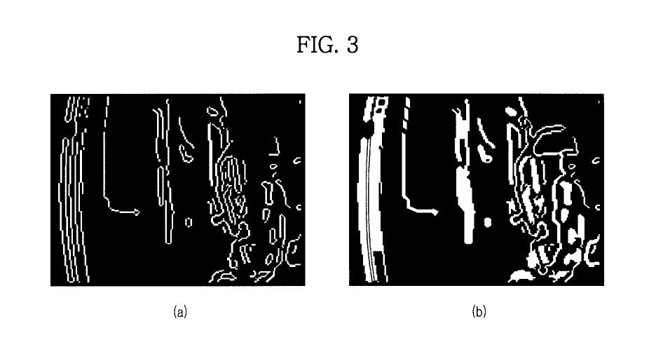

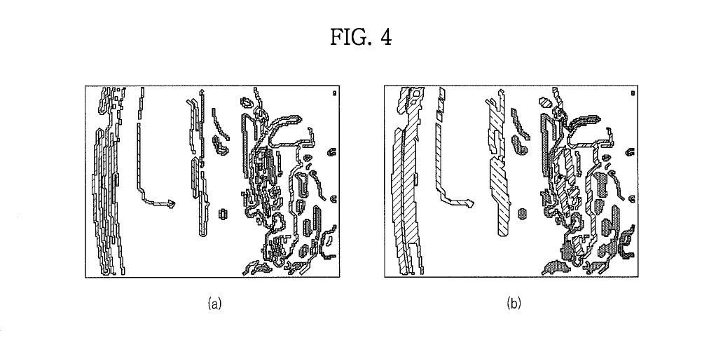

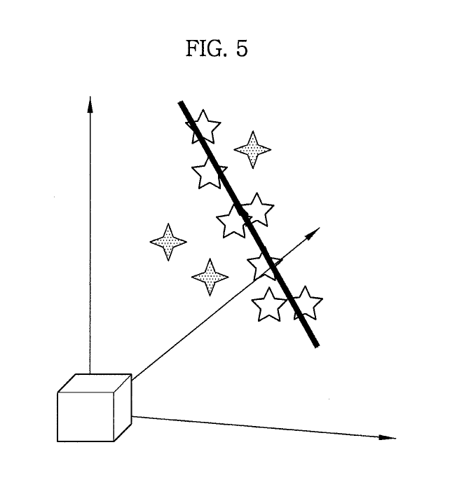

FIG. 1 is a block diagram schematically illustrating the construction of a three-dimensional (3D) edge extraction apparatus according to example embodiments. FIG. 2, parts (a) and (b), are views illustrating examples of an intensity image and a depth image acquired using a time of flight (TOF) camera. FIG. 3, parts (a) and (b), are views illustrating a two-dimensional (2D) edge image and a 2D edge candidate group image extracted from the intensity image acquired using the TOF camera. FIG. 4, parts (a) and (b), are views illustrating images matched with the 2D edge image and the 2D edge candidate group image. FIG. 5 is a view illustrating a 3D edge extraction result according to example embodiments.

Hereinafter, the construction and operation of the 3D edge extraction apparatus will be described in detail with reference to FIGS. 2(a) to 5.

The 3D edge extraction apparatus may include an image acquisition unit 100, an image conversion unit 106, a matching unit 112, a 3D distance information acquisition unit 114, and a 3D edge extraction unit 116. The image acquisition unit 100 may include an intensity image acquisition unit 102 and a depth image acquisition unit 104. The image conversion unit 106 may include a 2D edge image acquisition unit 108 and a 2D edge candidate group image acquisition unit 110.

The image acquisition unit 100 may include a camera to capture an environment. Generally, a TOF camera to measure both an intensity image and a depth image may be used. The image acquisition unit 100, corresponding to the TOF camera, may include the intensity image acquisition unit 102 and the depth image acquisition unit 104.

The intensity image may indicate the degree of brightness generated when infrared rays are applied to an object. Generally, eight bits may be used to indicate the degree of brightness. In this case, the intensity image may be expressed as a binary image indicating a total of 256 step brightnesses from 0 to 255. An example of the intensity image may be shown in FIG. 2(a). Generally, the intensity image may be expressed as a black and white binary image having a total of 256 step brightnesses as described above. However, the degree of brightness is omitted from FIG. 2(a) to distinguish the intensity image from the depth image, which will be described hereinafter.

The depth image may three-dimensionally express information of distance to the object measured using the TOF camera. More specifically, time may be measured from when infrared rays emitted from an infrared ray emission part of the TOF camera reach the object and return to an infrared ray receiving part of the TOF camera to calculate the distance to the object. This distance is based on which 3D image including the distance to the object is acquired. An example of the depth image is shown in FIG. 2(b). The depth image may include image information including colors according to the measured distance to the object. In particular, near parts may be expressed brightly, and far parts may be expressed darkly. In FIG. 2(b), colors may be distinguished by slanted lines.

The image conversion unit 106 may include the 2D edge image acquisition unit 108 and the 2D edge candidate group image acquisition unit 110. The image conversion unit 106 may extract a 2D edge image and a 2D edge candidate group image from the intensity image acquired by the intensity image acquisition unit 102.

The 2D edge image acquisition unit 108 may determine a part having a large brightness change or discontinuity of the image like a border line of the object as previously described as an edge to acquire a 2D edge image. The 2D edge image acquisition unit 108 may use a method employing gradient information and Laplacian information of an image or a canny edge detection method. An example of the 2D edge image is shown in FIG. 3(a). A part having a large brightness change or discontinuity of the intensity image shown in FIG. 2(a) may be extracted as an edge.

The 2D edge candidate group image acquisition unit 110 may dilate the edge part of the 2D edge image acquired by the 2D edge image acquisition unit 108 to acquire a 2D edge candidate group image. Dilating the edge part includes addition of image information within a predetermined range around the edge to the edge of the 2D edge image to acquire the 2D edge candidate group image. This may be performed using a dilation method applied to a binary image, which is a kind of image processing technology. An image to be processed and a structural element, such as a kernel, may be used to dilate the binary image. When the structural element of the kernel overlaps with the edge region while moving the kernel in the image to be processed, the part may be filled with white to dilate the edge. The edge part may be dilated for the following reasons. Generally, depth information of the depth image acquired by the TOF camera may be obtained using reflected infrared information, resulting in that the depth information has incorrect distance information including noise. To extract a physically continuous 3D edge, therefore, as much information as possible may be set as a candidate group to include as many inliers as possible as correct information, and outliers as incorrect information may be excluded. Consequently, the depth information candidate group spatially present around the 2D edge as well as the depth information on the 2D edge may be selected to extract the optimum edge information using a random sample consensus (RANSAC) algorithm, which will be described later. An example of the 2D edge candidate group image is shown in FIG. 3(b). The 2D edge candidate group image shown in FIG. 3(b) corresponds to the deep dilation of the edge part of the 2D edge image shown in FIG. 3(a).

The matching unit 112 may match the depth image acquired by the depth image acquisition unit 104 and the 2D edge candidate group image acquired by the 2D edge candidate group image acquisition unit 110. Matched images may be acquired by the matching unit 112. The matched images may include color information expressed according to the depth of the depth information in the edge candidate group part of the 2D edge candidate group image. Examples of the matched images are shown in FIGS. 4(a) and 4(b). FIG. 4(a) shows matching of the 2D edge image and the depth image. FIG. 4(b) shows matching of the 2D edge candidate group image and the depth image. As will be described later, the 2D edge candidate group image may be used to reduce an error during extraction of a 3D edge. The 2D edge candidate group image may be matched with the depth image to extract the 3D edge using a RANSAC algorithm.

The 3D distance information acquisition unit 114 may acquire 3D distance information using the matched images and a pinhole camera module. Both the image obtained by matching the 2D edge image and the depth image and the image obtained by matching the 2D edge candidate group image and the depth image may be used as the matched images. The image obtained by matching the 2D edge candidate group image and the depth image may be used to reduce an error as described above. The 3D distance information may be calculated using the following method. When image coordinate values (u, v) of the image information, a corresponding depth value z, and the following camera feature information are known, distance data (X, Y) may be calculated using Equation 1.

In Equation 1, f represents focal length of camera, and (u₀, v₀) represents principal point of camera (optical center of lens).

$$X = \frac{( u - {u}_{0} ) \times Z}{f} \\ Y = \frac{( v - {v}_{0} ) \times Z}{f} \qquad [ Equation 1 ]$$

In particular, 3D distance information of image information corresponding to the edge candidate group of the matched image may be acquired using Equation 1 above, which is used to perform a RANSAC algorithm, which will be described hereinafter.

The 3D edge extraction unit 116 may extract a 3D edge using the RANSAC algorithm based on the 3D distance information acquired by the 3D distance information acquisition unit 114. That is, the RANSAC algorithm may be applied to the 2D edge candidate group information to extract a 3D edge. The RANSAC algorithm is an iterative method to estimate parameters of a mathematical model from a set of observed data with contains outliers. The following 3D equation of a straight line is used as the model.

$$\frac{x - {x}_{1}}{a} = \frac{μ - {μ}_{1}}{b} = \frac{z - {z}_{1}}{c}$$

Information may be randomly selected from an information candidate group to estimate a model, information having distances to the straight line within a predetermined range may be considered as inliers, information having distances to the straight line out of the predetermined range may be considered as outliers, and the optimum value of the model may be calculated. At this time, parameters a, b and c, by which the distance sum of the inliers is minimized, may be calculated using a least square method. RANSAC may probabilistically set the repetition number of the iterative process. The iterative process may be repeated several times to acquire the most probabilistically correct equation of a straight line. FIG. 5 is a view illustrating a 3D edge extraction result according to example embodiments. Outliers may have slant lines, and inliers may not have slant lines. The outlier information may be removed, and the inlier information may be connected to acquire a 3D equation of a straight line.

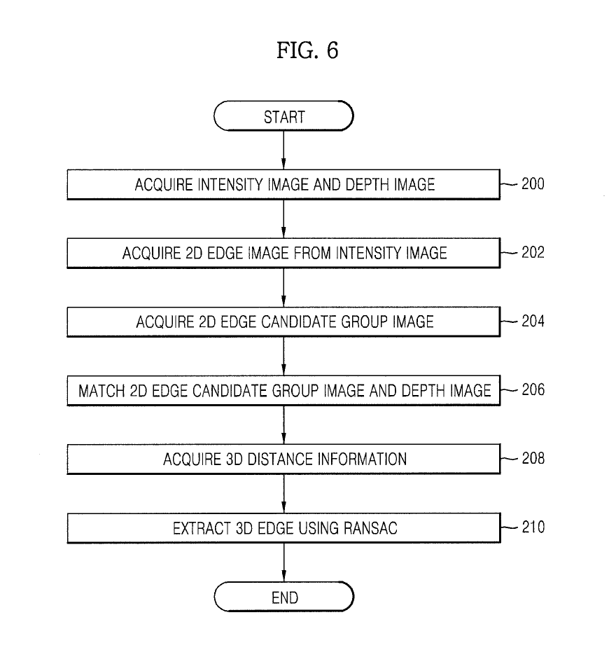

FIG. 6 is a flow chart illustrating a 3D edge extraction method according to example embodiments. Hereinafter, the 3D edge extraction method will be described.

First, a 2D intensity image and a depth image may be acquired using the TOF camera (200). Subsequently, a part having a large brightness change or discontinuity of the acquired 2D intensity image may be extracted to acquire a 2D edge image (202). After the acquisition of the 2D edge image, an edge part of the 2D edge image may be dilated to acquire a 2D edge candidate group image (204). This may be performed to reduce an error such as a discontinuity processed due to brightness change of an actually continuous part as previously described.

The 2D edge candidate group image may be matched with the depth image to acquire a matched image (206). This matched image may include coordinate information of pixels corresponding to the edge candidate group of the intensity image and depth information of the pixels. Subsequently, 3D distance information may be acquired using the depth information of the pixels corresponding to the edge candidate group and the pinhole camera model (208). 3D distance information including depth information of the pixels corresponding to the edge candidate group and 2D distance information may be acquired. A 3D edge may be extracted based on the acquired 3D distance information using a RANSAC algorithm (210).

As is apparent from the above description, an edge may be extracted from the 2D distance information, and, at the same time, an edge may be extracted from the depth information, thereby more accurately and stably achieving 3D edge extraction. Also, the amount of 3D information may be reduced to increase calculation speed, thereby achieving 3D edge extraction.

The above-described embodiments may be recorded in non-transitory computer-readable media including program instructions to implement various operations embodied by a computer. The media may also include, alone or in combination with the program instructions, data files, data structures, and the like. Examples of computer-readable media (computer-readable storage devices) include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. The computer-readable media may be a plurality of computer-readable storage devices in a distributed network, so that the program instructions are stored in the plurality of computer-readable storage devices and executed in a distributed fashion. The program instructions may be executed by one or more processors or processing devices. The computer-readable media may also be embodied in at least one application specific integrated circuit (ASIC) or Field Programmable Gate Array (FPGA). Examples of program instructions include both machine code, such as produced by a compiler, and files containing higher level code that may be executed by the computer using an interpreter. The described hardware devices may be configured to act as one or more software modules in order to perform the operations of the above-described exemplary embodiments, or vice versa.

Although embodiments have been shown and described, it should be appreciated by those skilled in the art that changes may be made in these embodiments without departing from the principles and spirit of the disclosure, the scope of which is defined in the claims and their equivalents.

What is claimed is:

1. A three-dimensional (3D) edge extraction method, comprising:
acquiring a two-dimensional (2D) intensity image and a depth image using a time of flight (TOF) camera;
acquiring a 2D edge image from the 2D intensity image; and
extracting a 3D edge using a matched image obtained by matching the 2D intensity image and the depth image.

2. The 3D edge extraction method according to claim 1, further comprising acquiring 3D distance information of an edge part of the matched image.

3. The 3D edge extraction method according to claim 2, wherein the 3D distance information comprises depth information of the edge part of the matched image and 2D distance information of the edge part calculated using a pinhole camera.

4. The 3D edge extraction method according to claim 2, wherein the 3D edge is extracted using a random sample consensus (RANSAC) algorithm.

5. A three-dimensional (3D) edge extraction method, comprising:
acquiring a two-dimensional (2D) intensity image and a depth image using a time of flight (TOF) camera;
acquiring a 2D edge image from the 2D intensity image;
dilating an edge part of the 2D edge image to acquire a 2D edge candidate group image; and
extracting a 3D edge using a matched image obtained by matching the 2D edge candidate group image and the depth image.

6. The 3D edge extraction method according to claim 5, further comprising acquiring 3D distance information of an edge candidate group part of the matched image.

7. The 3D edge extraction method according to claim 6, wherein the 3D distance information comprises depth information of the edge candidate group part of the matched image and 2D distance information of the edge candidate group part calculated using a pinhole camera.

8. The 3D edge extraction method according to claim 6, wherein the 3D edge is extracted using a random sample consensus (RANSAC) algorithm.

9. A three-dimensional (3D) edge extraction apparatus, comprising:
an image acquisition unit having a time of flight (TOF) camera to acquire a two-dimensional (2D) intensity image and a depth image;
a 2D edge image acquisition unit to extract a 2D edge image from the 2D intensity image;
a matching unit to match the 2D edge image and the depth image; and
a 3D edge extraction unit to extract a 3D edge from a matched image acquired by the matching unit.

10. The 3D edge extraction apparatus according to claim 1, further comprising a 3D distance information acquisition unit to acquire 3D distance information of an edge part of the matched image acquired by the matching unit.

11. The 3D edge extraction apparatus according to claim 9, wherein the 3D edge extraction unit extracts the 3D edge using a random sample consensus (RANSAC) algorithm.

12. A three-dimensional (3D) edge extraction apparatus, comprising:
an image acquisition unit having a time of flight (TOF) camera to acquire a two-dimensional (2D) intensity image and a depth image;
a 2D edge image acquisition unit to extract a 2D edge image from the 2D intensity image;
a 2D edge candidate group image acquisition unit to dilate an edge part of the 2D edge image to acquire a 2D edge candidate group image;
a matching unit to match the 2D edge candidate group image and the depth image; and
a 3D edge extraction unit to extract a 3D edge from a matched image acquired by the matching unit.

13. The 3D edge extraction apparatus according to claim 12, further comprising a 3D distance information acquisition unit to acquire 3D distance information of an edge part of the matched image acquired by the matching unit.

14. The 3D edge extraction apparatus according to claim 12, wherein the 3D edge extraction unit extracts the 3D edge using a random sample consensus (RANSAC) algorithm.

15. At least one non-transitory computer readable medium comprising computer readable instructions that control at least one processor to implement the method of claim 1.

16. At least one non-transitory computer readable medium comprising computer readable instructions that control at least one processor to implement the method of claim 5.
